(19) United States
(12) Patent Application Publication
(10) Pub. No.: US 2025/0151700 A1
(43) Pub. Date: May 15, 2025

(54) PET TOYS

(71) Applicant: Worldwise, Inc., Novato, CA (US)

(72) Inventors: Aimee Diskin, Napa, CA (US); Hannah Rosenberg, San Francisco, CA (US); Cristen Underwood, Westminster, CO (US); Muhan Zhang, Daly City, CA (US)

(21) Appl. No.: 18/946,832

(22) Filed: Nov. 13, 2024

Related U.S. Application Data
(60) Provisional application No. 63/598,314, filed on Nov. 13, 2023.

(51) Int. Cl. A01K 15/02

(52) U.S. Cl. CPC A01K 15/025

(57) ABSTRACT

A pet toy includes a motion assembly and a pet engagement member. The motion assembly includes a motor that can be activated and deactivated. The pet engagement member moves erratically when the motor is in the activated condition.

### CROSS-REFERENCE TO RELATED APPLICATIONS

The present application claims the benefit of U.S. Provisional Application Ser. No. 63/598,314, filed on Nov. 13, 2023, entitled PET TOYS (Attorney Docket No. 40472.04445), the entire disclosure of which is incorporated herein by reference in its entirety.

### TECHNICAL FIELD

The present application relates generally to pet toys and in particular to pet toys that include an internal mechanism for causing the toy to move.

### BACKGROUND

Dogs (and other pets) benefit from playing with toys that encourage interaction, are entertaining, and that are durable to withstand the kind of tough play in which dogs engage.

### SUMMARY

Exemplary embodiments of pet toys are disclosed herein.

An example of a pet toy described herein has a motion assembly and a pet engagement member. The motion assembly includes a motor that has an activated configuration and a deactivated configuration. The pet engagement member that is configured to move erratically when the motor is in the activated configuration.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a perspective view of an example pet toy;

FIG. 2 is a front view of an example pet engagement member for the pet toy of FIG. 1;

FIG. 3 is an exploded view of an example motion assembly for the pet toy of FIG. 1;

FIG. 4 is a perspective view of an example housing for the motion assembly of FIG. 3;

FIG. 5 is a front view of the housing of FIG. 4;

FIG. 6 is a left-side view of the housing of FIG. 4;

FIG. 7 is a right-side view of the housing of FIG. 4;

FIG. 8 is a perspective view of the pet toy of FIG. 1 showing example movements of the pet toy;

FIG. 9 is a perspective view of another example pet toy;

FIG. 10 is a top view of an example cover for the pet toy of FIG. 9;

FIG. 11 is a perspective view of an example motion assembly for the pet toy of FIG. 9;

FIG. 12 is an exploded view of the motion assembly of FIG. 11;

FIG. 13 is a front view of the motion assembly of FIG. 11;

FIG. 14 is a side view of the motion assembly of FIG. 11;

FIG. 15 is a perspective view of an example connector for the motion assembly of FIG. 11;

FIG. 16 is an example pet engagement member for the pet toy of FIG. 9;

FIG. 17 illustrates an example connection between the connector of FIG. 15 and the pet engagement member of FIG. 16;

FIG. 18 is a top view of another example pet toy;

FIG. 19 is a side view of the example pet toy of FIG. 18;

FIG. 20 is an exploded view of the pet toy of FIG. 18;

FIG. 21 is a bottom view of the pet toy of FIG. 18;

FIG. 22 is a perspective view of an example motion assembly for the pet toy of FIG. 18;

FIG. 23 is a perspective view of the motion assembly of FIG. 22;

FIG. 24 is a front view of an example housing of the motion assembly of FIG. 22;

FIG. 25 is a side view of the housing of FIG. 24;

FIG. 26 illustrates an example pet engagement member for the pet toy of FIG. 18;

FIG. 27 is a perspective view of another example pet toy;

FIG. 28 is a sectional view of the pet toy of FIG. 27;

FIG. 29 is a bottom view of the pet toy of FIG. 27 with an access panel shown in an open position;

FIG. 30 illustrates an example access panel for the pet toy of FIG. 27;

FIG. 31 is a schematic view of the pet toy of FIG. 27 showing a first portion of an example access panel of FIG. 30 attached to an outer cover of the pet toy;

FIG. 32 is a perspective view of an example motion assembly for the pet toy of FIG. 27;

FIG. 33 is an exploded view of the motion assembly of FIG. 32;

FIG. 34 is a top view of an example housing for the motion assembly of FIG. 32;

FIG. 35 is a side view of the housing of FIG. 34;

FIG. 36 is a bottom view of the example housing of FIG. 34; and

FIG. 37 is a perspective view of the pet toy of FIG. 27 with an alternative cover.

### DETAILED DESCRIPTION

The following description refers to the accompanying drawings, which illustrate specific embodiments of the present disclosure. Other embodiments having different structures and operation do not depart from the scope of the present disclosure.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Additionally, as used herein, the term “exemplary” is intended to mean serving as an illustration or example of something and is not intended to indicate a preference.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; and X employs both A and B. In addition, the articles “a” and “an” as used in this application and the appended claims should generally be construed to mean “one or more” unless specified otherwise or clear from the context to be directed to a singular form.

Numerical values or ranges stated herein are understood to encompass values at or near the stated value and/or above or below the stated range. For this application, the stated value can encompass plus or minus 5% of the value and the stated range can encompass plus or minus 5% of the extent of the range. In addition, the stated value or range can include a margin of error for the value or range typical in the art for the property being measured. The stated value or range can also encompass those values and ranges that would be considered equivalent to the stated value or range by one of ordinary skill in the art. As an example, a distance expressed as a range of 2 inches to 12 inches is understood to include durations above and below the ends of the range by 5% of the extent of the 10 inch range—e.g., 1.5 inches to 12.5 inches. As another example, the size of an object expressed as a value of 5 inches includes values above and below 5 inches that are within the margin of error of a tool typically used to measure objects of that size. As yet another example, an angle between two components expressed as a value of 20degrees includes values above and below 20 degrees that would be considered equivalent by one of ordinary skill in the art.

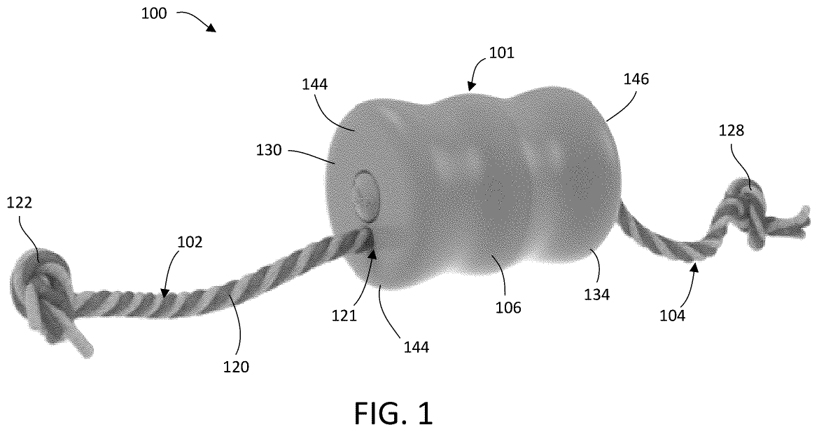

FIGS. 1-8 illustrate an example pet toy 100 that includes a motion assembly 101, a first pet engagement member 102, and a second pet engagement member 104. The motion assembly includes a housing 106 and a motor assembly 108 disposed within the housing 106. The housing 106 can be made of a durable material such that pets are inhibited from accessing the motor assembly 108 when playing with the pet toy 100. For example, the housing 106 can be made of thermoplastic rubber (TPR) or any other suitable material that is capable of inhibiting a pet from breaking through the housing 106 and engaging the motor assembly 108.

Referring to FIG. 3, in some implementations, the housing 106 can include a first member 114 and a second member 116 that are configured to be connected together to define an interior 118 for holding the motor assembly 108. In some examples, the first and second members 114, 116 can be connected by an adhesive, such as, for example, any adhesive that is strong enough to inhibit a pet from disconnecting the first and second members 114, 116 from each other during play. It should be understood, however, that the first and second members 114, 116 can be connected in a variety of ways. It should also be understood that the housing 106 can have any number of members. For example, the housing 106 can be made of a single piece of material or the housing 106 can be made of a plurality of members that are connected together to form the housing 106.

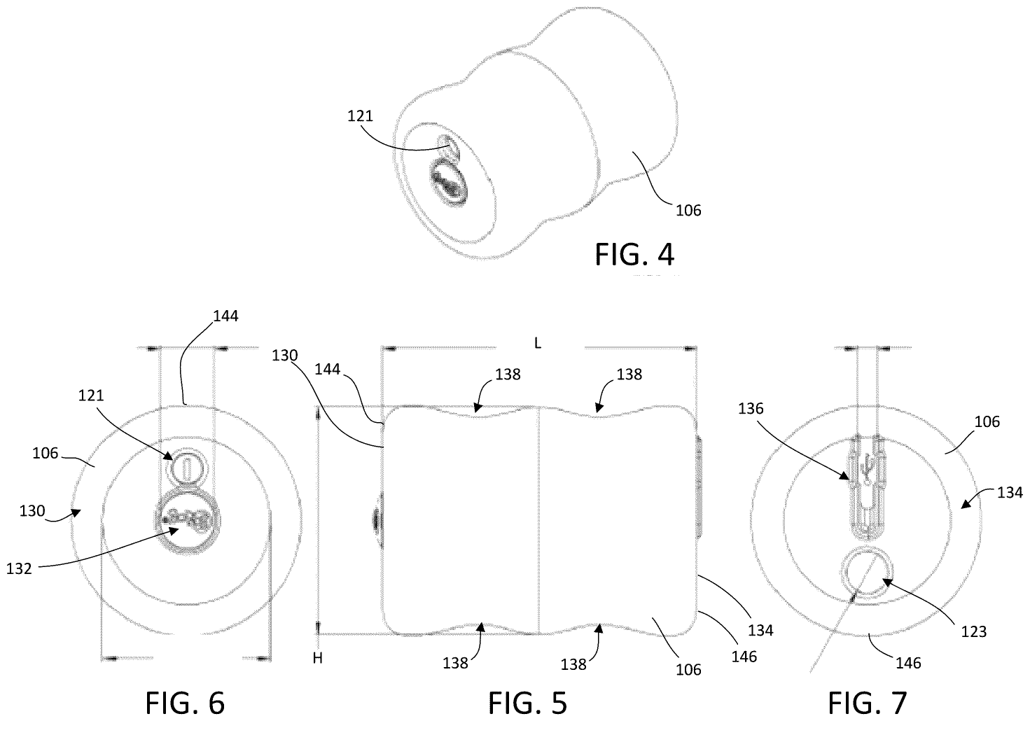

Referring to FIGS. 4-7, the housing 106 can be sized and shaped to facilitate movement of the pet toy 100 and encourage interaction with the pet. In some examples, the housing 106 can have a length L (FIG. 5) of between about 80 mm and about 200 mm, such as about 128 mm. In some examples, the housing 106 can have a height H (FIG. 5) of between about 60 mm and about 120 mm, such as about 92.2 mm. Referring to FIGS. 6 and 7, the housing 106 is shown as having a circular shape when viewed from a side of the pet toy 100. However, it should be understood that the housing 106 can have any other suitable shape. Referring to FIG. 5, the housing 106 can included an uneven shape along the length (e.g., via curved portions 138) to further facilitate an erratic movement of the pet toy 100.

Referring to FIG. 6, a first side 130 of the housing 106 can include an opening 121 for receiving a pet engagement member 102, 104 and an activation member 132 (e.g., a button) that is configured to engage the motor assembly 108 (FIG. 3) and move a motor 112 (FIG. 3) between activated and deactivated configurations. Referring to FIG. 7, a second side 134 of the housing 106 can include an opening 123 for receiving another pet engagement member 102, 104 and a charging port 136 for receiving a charging device (e.g., a USB charger) to allow a user to recharge a power source of the motion assembly 101.

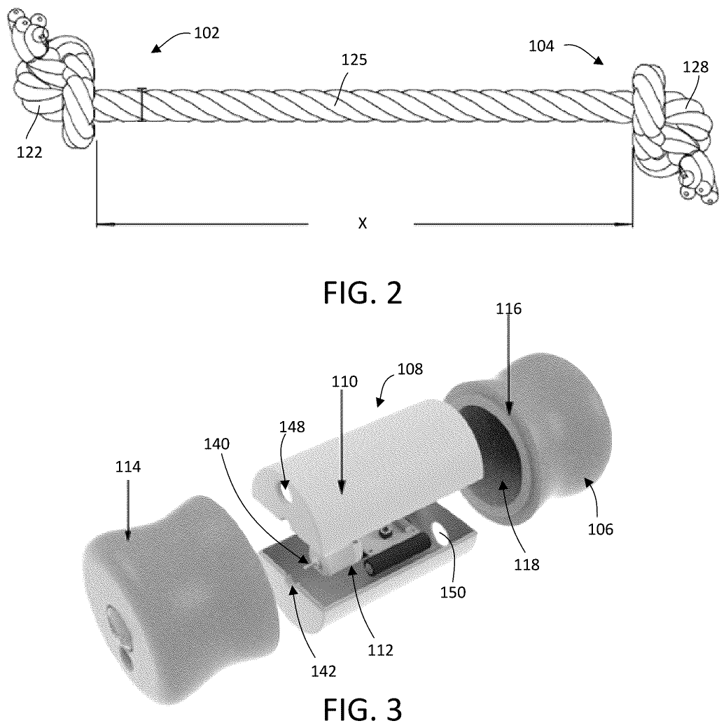

Referring to FIGS. 1 and 2, the pet toy 100 can include one or more pet engagement members 102, 104. In some implementations, the pet engagement members 102, 104 can be separate components that are each connected to the housing 106. In these implementations, referring again to FIG. 1, the first engagement member 102 can have a main body 120 that extends through an opening 121 of the housing 106, a first stop member 122 (e.g., a knot) disposed at an exposed end of the main body 120, and a second stop member (e.g., a knot that is not shown) disposed at the other end of the main body 120 such that the second stop member is within the housing and prevents the first engagement member 102 from being disconnected from the housing 106 by moving through the opening 121. The second engagement member 104 can have a main body 126 that extends through an opening 123 (FIG. 7) of the housing 106, a first stop member 128 (e.g., a knot) disposed at an exposed end of the main body 126, and a second stop member (e.g., a knot that is not shown) disposed at the other end of the main body 120 such that the second stop member is within the housing and prevents the second engagement member 104 from being disconnected from the housing 106 by moving through the opening 123.

In other implementations, such as the example shown in FIG. 2, the pet engagement members 102, 104 can be integral with each other. In this example, the pet engagement member 102 has a stop member 122 (e.g., a knot) at an end that is exposed from a first side of the housing 106, the second engagement member has a stop member 128 (e.g., a knot) that is at an end that is exposed from a second side of the housing 106, and a main body 125 that extends between the stop members 122 is movable relative to the housing with stop members 122, 128 being configured to prevent the pet engagement members 102, 104 from being disconnected from the housing 106. In various examples, the combined length X of the engagement members 102, 104 can be between about 100 mm and about 200 mm, such as about 152.4 mm.

The pet engagement members 102, 104 can take any suitable form that is capable of flexibly moving as the motor assembly 108 causes the housing 106 to move. For example, each of the pet engagement members 102, 104 can be a rope or any other flexible material that is capable of flexibly moving, or any combination thereof. In the illustrated example, the pet engagement members 102, 104 are cotton ropes. However, it should be understood that the pet engagement members 102, 104 can be made of any other suitable material. While the illustrated example shows the pet toy 100 having two pet engagement members, it should be understood that the pet toy 100 can have any suitable number of pet engagement members.

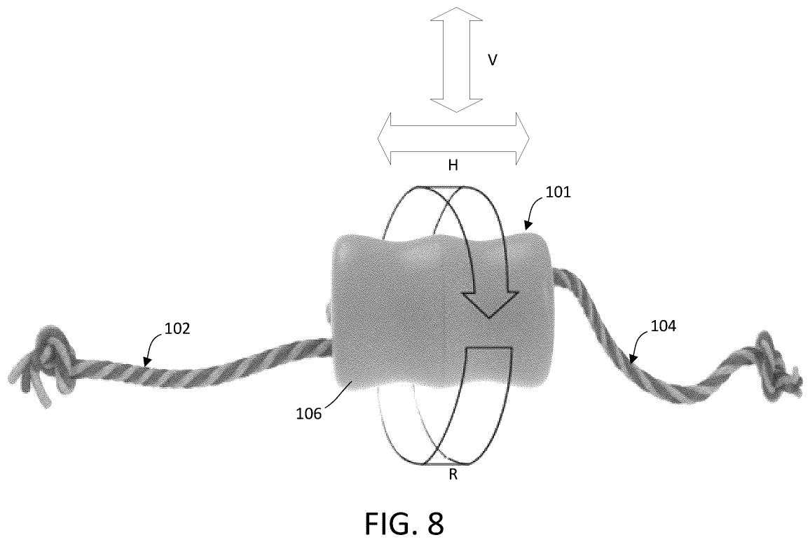

Referring to FIG. 3, the motor assembly 108 can include a motor assembly housing 110, a motor 112, and a power source (e.g., a battery). The motor 112 and power source are disposed within the motor assembly housing 110. In the illustrated example, the motor 112 has a motor shaft 140 that extends through an opening 142 in the motor assembly housing 110, where the motor shaft 140 can be connected to the housing 106 (by any suitable means) such that movement of the motor shaft 140 causes the housing 106 and, consequently, the pet engagement members 102, 104 to move. The motor 112 has an activated configuration and a deactivated configuration, where the motor 112 is configured to move the pet toy 100 when in the activated configuration. In some examples, the motor 112 is configured to erratically move the pet toy 100, such as, for example, by intermittent movement of a motor shaft 140. Referring to FIG. 8, the motor 112 can be configured to rotate the housing 106 in a direction R (or the opposite direction thereof), move the housing 106 in a vertical direction V, move the housing 106 in a horizontal direction H, or any combination thereof. In various examples, the motor assembly 108 can include a control circuit (not shown) connected between the motor 112 and the power source, where the control circuit can be configured to cause the motor 112 to move intermittently, change directions, operate at different speeds, and/or operate in a random fashion. In some examples, the control circuit can be configured to move the motor 112 from the activated configuration to the deactivated configuration after a predetermined amount of time (e.g., 10 minutes).

Referring to FIGS. 4-8, the pet engagement members 102, 104 can be connected to the housing 106 such that the first pet engagement member 102 is offset from the second pet engagement member 104. For example, the opening 121 for receiving the first pet engagement member 102 can be located proximate a side edge 144 of a first side 130 of the housing 106, and the opening 123 for receiving the second pet engagement member 104 can be located proximate a side edge 146 of the second side 134 of the housing 106 that is opposite the side edge 144. Referring to FIG. 3, in examples in which the engagement members 102, 104 are integral with each other, the motor assembly housing 110 can include openings 148, 150 that allow for the engagement members 102, 104 to extend through the motor assembly housing 110. The offset positioning of the pet engagement members 102, 104 facilitates erratic movement of the engagement members 102, 104 and encourages interaction with the pet.

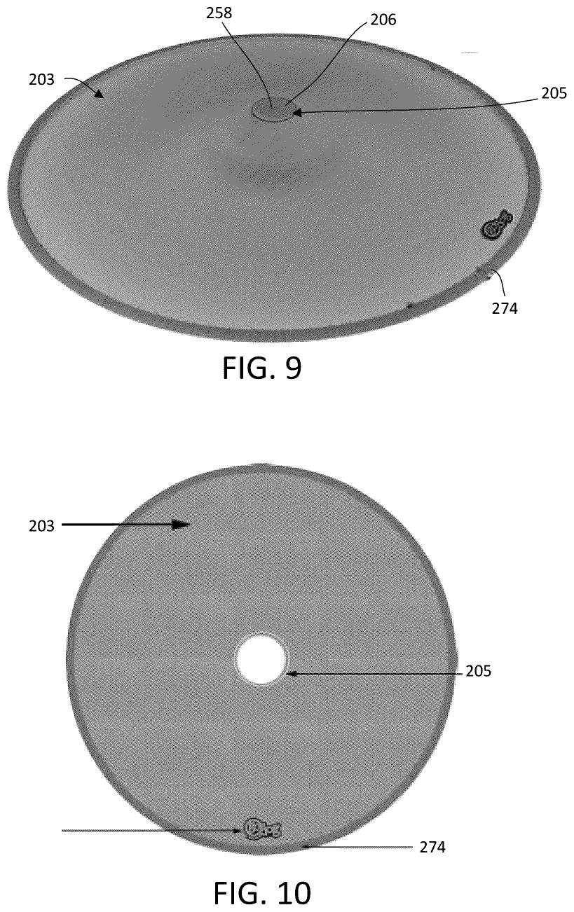

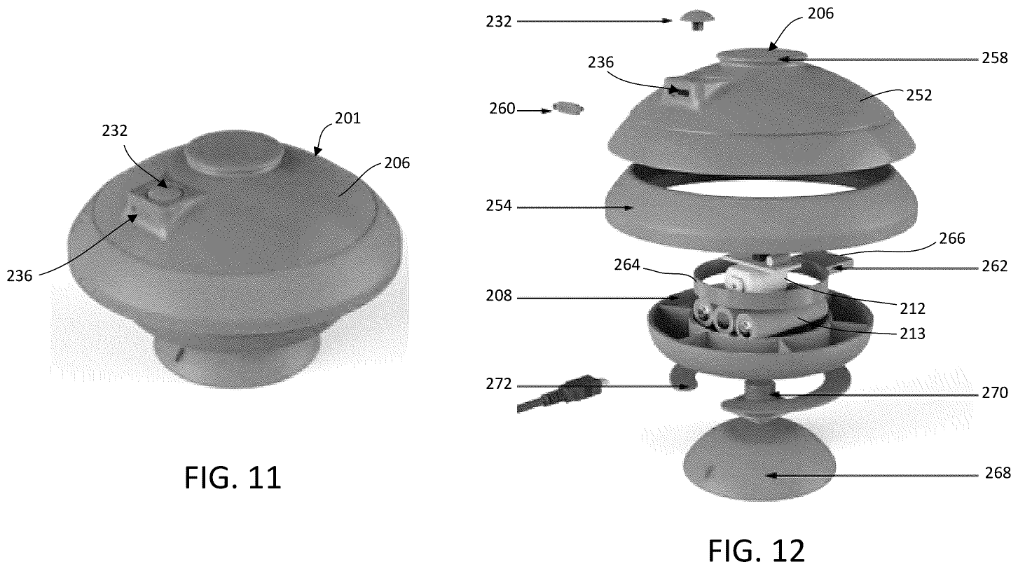

FIGS. 9-17 illustrate an example pet toy 200 that includes a motion assembly 201, a pet engagement member 202, and a cover 203. Referring to FIGS. 11-14, the motion assembly 201 includes a housing 206 and a motor assembly 208 disposed within the housing 206. The housing 206 can be made of a durable material such that pets are inhibited from accessing the motor assembly 208 when playing with the pet toy 200. For example, the housing 206 can be made of acrylonitrile butadiene styrene (ABS) or any other suitable material that is capable of inhibiting a pet from breaking through the housing 206 and engaging the motor assembly 208.

Referring to FIG. 12, the housing 206 can include a top member 252, a shield member 254, and a bottom member 256. The bottom member 256 is configured to hold the motor assembly 208. The shield member 254 is configured to protect the motor assembly 208 as a pet is playing with the pet toy 200. The top member 252 is configured to connect to the cover 203 (FIGS. 1-2) and protect the motor assembly 208 as a pet is playing with the pet toy. In some examples, the top member 258 can include a connector 258 that is configured to receive the cover 203. The cover 203 can be connected to the connector 258 by any suitable means, such as, for example, an adhesive or any other means that inhibits a pet from disconnecting the cover 203 from the housing 206 during play. In some implementations, the top member 252 can include an activation member 232 (e.g., a button) that is configured to engage the motor assembly 208 and move a motor 212 between activated and deactivated configurations. The top member 252 can also include a charging port 236 for receiving a charging device (e.g., a USB charger) to allow a user to recharge a power source of the motion assembly 201. In some examples, the housing 206 includes a charging port cover 260 that can cover the charging port 236 during play.

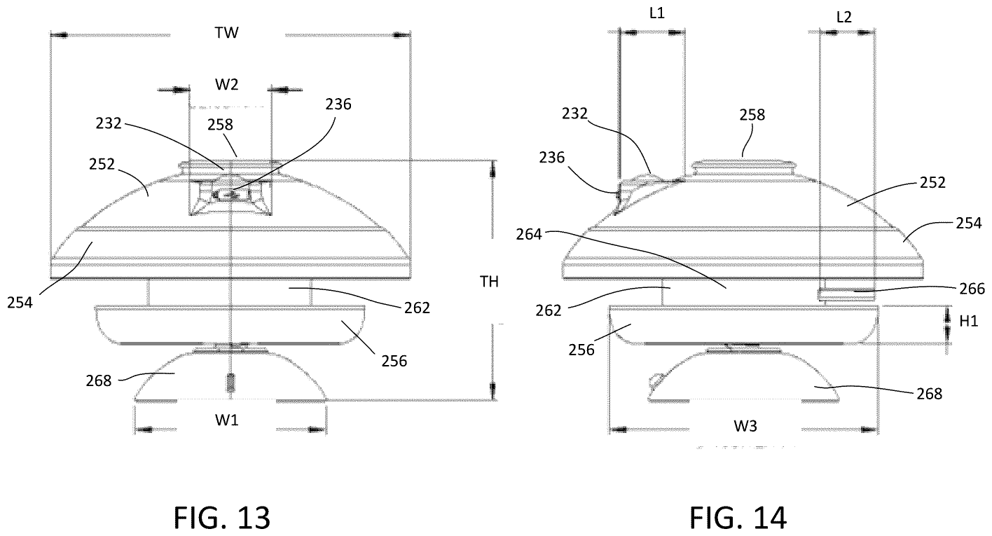

Referring to FIGS. 13-14, in some implementations, the housing 206 can have a total width TW of between about 100 mm and about 200 mm, such as about 145 mm. The housing 206 can have a total height TH (including the suction device 268) of between about 50 mm and about 150 mm, such as about 96.5 mm. The suction cup can have a width W1 of between about 50 mm and about 100 mm, such as about 76.7 mm. The portion of the top member 252 of the housing 206 that includes the activation member 232 and the charging port 236 can have a width W2 of between about 20 mm and about 40 mm, such as about 32.7 mm. The portion of the top member 252 of the housing 206 that includes the activation member 232 and the charging port 236 can have a length L1 of between about 15 mm and about 35 mm, such as about 26.6 mm. The second portion 266 of the connector 262 can have a length L2 of between about 10 mm and about 30 mm, such as about 21.7 mm. The bottom member 256 of the housing 206 can have a width W3 of between about 60 mm and about 160 mm, such as about 108.1 mm. The bottom member 256 of the housing 206 can have a height H1 of between about 5 mm and about 25 mm, such as about 15.2 mm.

Referring to FIG. 12, in some examples, the motion assembly includes a suction device 268 that removably attaches the housing 206 to a floor surface and inhibits movement of the housing 206 relative to the floor surface during use of the pet toy 200. The suction device 268 can take any suitable form that is capable of removably attaching the housing 206 to the floor surface. The suction device 268 can be removably connected to the housing 206 by a fastener 270 (e.g., a screw connector). In instances in which the suction device 268 is removed from the pet toy 200 or the pet toy 200 does not include such a suction device 268, the pet toy 200 can include an anti-slip member 272 that prevents the housing 206 from sliding during use of the pet toy 200.

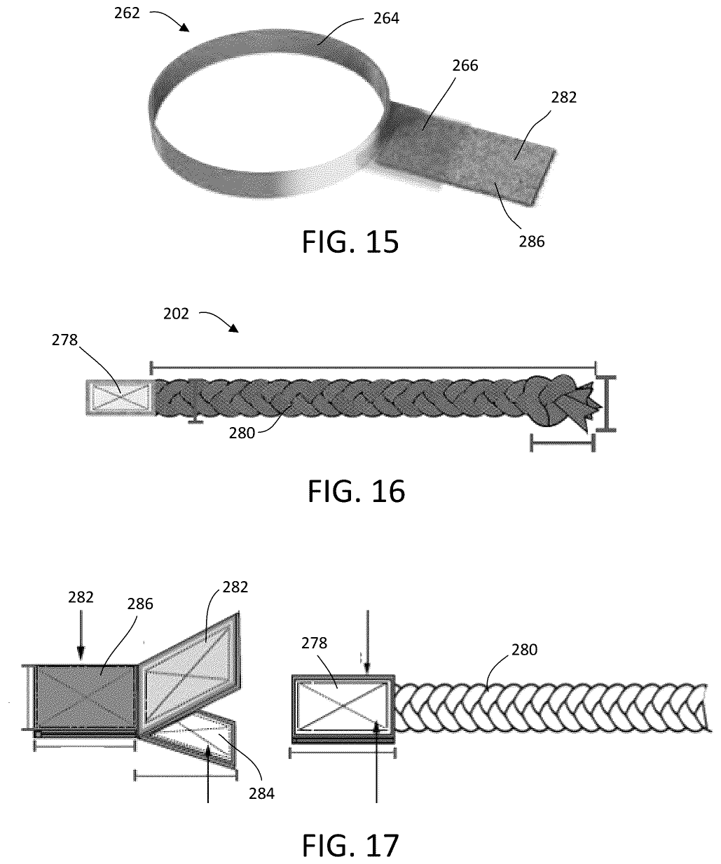

The motor assembly 208 includes a motor 212, a power source 213 (e.g., a battery), and a connector 262. The motor 212 and power source 213 are disposed in the housing 206. Referring to FIGS. 12 and 15, the connector 262 includes a first portion 264 that is operatively connected to the motor 212 and a second portion 266 that is connected to the pet engagement member 202 (FIGS. 16-17). The motor 212 can have motor shaft (not shown) that can be operatively connected to the first portion 264 of the connector 262 (by any suitable means) such that movement of the motor shaft 140 causes the first portion 264 of the connector 262 and, consequently, the second portion 266 and pet engagement member 202 to rotate relative to the housing 206. The motor 212 has an activated configuration and a deactivated configuration, where the motor 212 is configured to move the engagement member 202 when in the activated configuration.

In some examples, the motor 212 is configured to erratically move the pet engagement member 202, such as, for example, by intermittent movement of a motor shaft. In various examples, the motor assembly 208 can include a control circuit (not shown) connected between the motor and the power source, where the control circuit can be configured to cause the motor 212 to move intermittently, change directions, operate at different speeds, and/or operate in a random fashion. In some examples, the control circuit can be configured to move the motor 212 from the activated configuration to the deactivated configuration after a predetermined amount of time (e.g., 10 minutes).

Referring to FIGS. 9 and 10, the cover 203 is configured to cover the pet engagement member 202 and at least a portion of the housing 206. The cover 203 can be made of a flexible material (e.g., nylon) such that the cover 203 flexes or moves when engaged by a moving pet engagement member 202. In some instances, an inner portion of the cover may have a polyester mesh pad applied to the inner surface of the flexible material to provide added strength to the cover 203 and prevent a pet from tearing apart the cover 203 during play. The cover 203 has an opening 205 for receiving the housing (e.g., the connector 258 of the housing 206). The cover 203 can include an outer portion 274 that is configured to maintain the cover 203 in contact with a ground surface during play. The outer portion 274 can include a polypropylene webbing that is folded into a binding of the flexible material of the cover 203. The outer portion 274 can be durable to prevent a pet from tearing apart the cover 203 during play.

Referring to FIG. 16, the pet engagement member 202 can include a connector 278 and a flexible member 280. The connector 278 can be configured to connect to a connector 282 (FIG. 17) that is attached to the second portion 266 of the connector 262 of the motor assembly 208. The connector 278 can be, for example, a double-sided fastener that includes hooks or loops of a hook and loop connection. It should be understood, however, the connector 278 can take any other suitable form that is capable of connecting to the connector 262 of the motor assembly 208. The flexible member 280 can be a rope or any other flexible material that is capable of flexibly moving, or any combination thereof. In the illustrated example, the flexible member 280 is a braided rope. In this example, the strands of the braided rope 280 can be made of a polyester mesh material that is configured to be durable to prevent the pet engagement member 202 from tearing apart during play. While the illustrated example shows the pet toy 200 having one pet engagement member, it should be understood that the pet toy 200 can have any suitable number of pet engagement members.

FIG. 17 illustrates an example connection between the connector 278 of the pet engagement member 202 and a connector 282 that is attached to the connector 262 of the motor assembly 208. The connector 282 can include a first flap portion 284 and a second flap portion 286 that are connected to a tab member 286. The first flap portion 282 can include hooks or loops of a hook and loop connection such that it can connect to the other of the hooks or loops on a first side of the connector 278, and the second flap portion 285 can include hooks or loops of a hook and loop connection such that it can connect to the other of the hooks or loops on a second side of the connector 278. The tab member 286 can be connected to the second portion 266 of the connector 262 of the motor assembly 208. In various implementations, the tab member 286 may be configured to be removed (e.g., break away) from the second portion 266 of the connector 262 if a substantial amount of force is applied to the pet engagement member 208. This is advantageous because it prevents a pet from damaging the housing 206 and/or motor assembly 208 due to a large amount of force being applied to the pet engagement member 208 during play. That is, if the tab member 286 did not break away from the connector 262, the pet could cause damage to the housing 206 and or motor assembly 208 providing a substantial amount of force to the pet engagement member 202 that would consequently cause a substantial amount of force to be applied to the housing 206 and motor assembly 208.

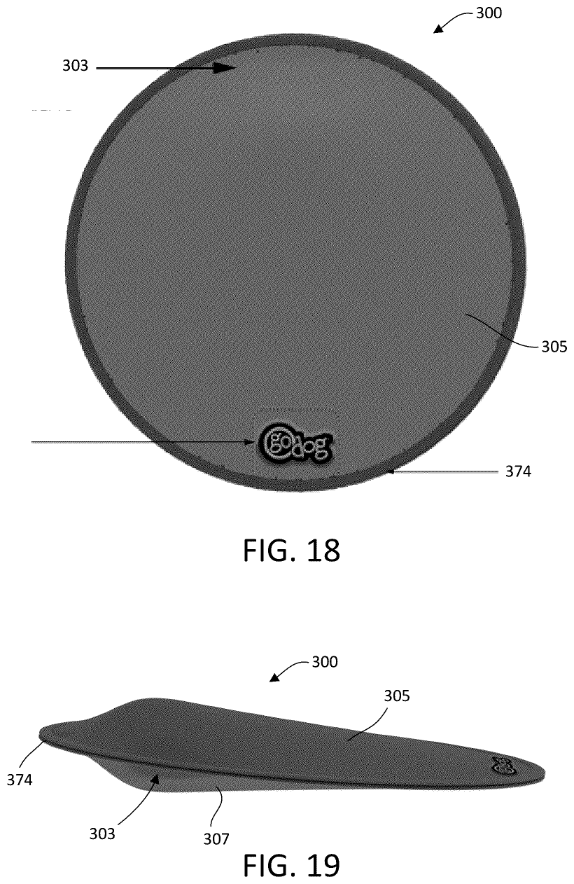

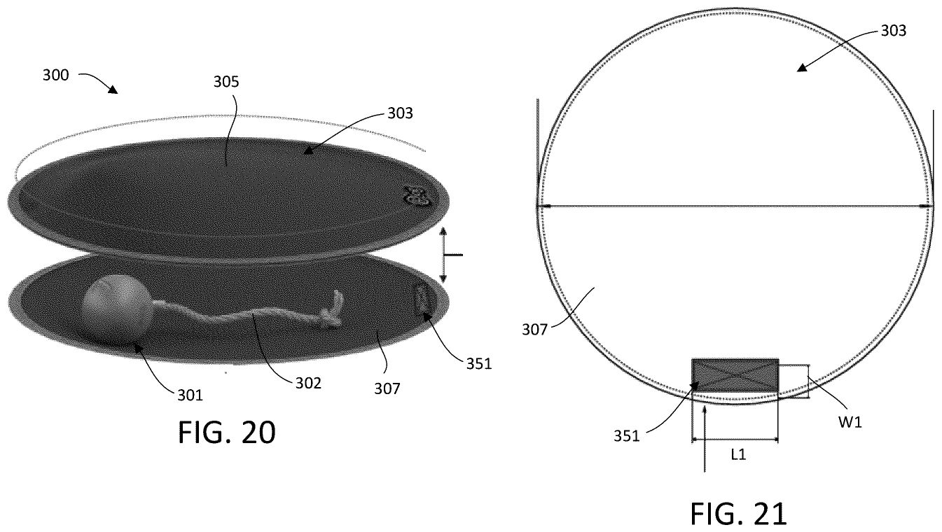

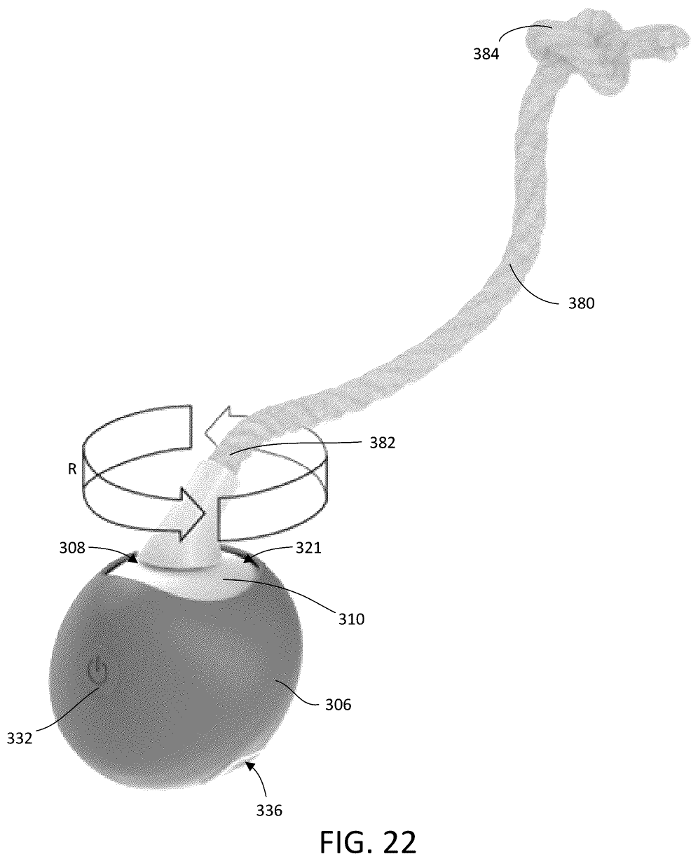

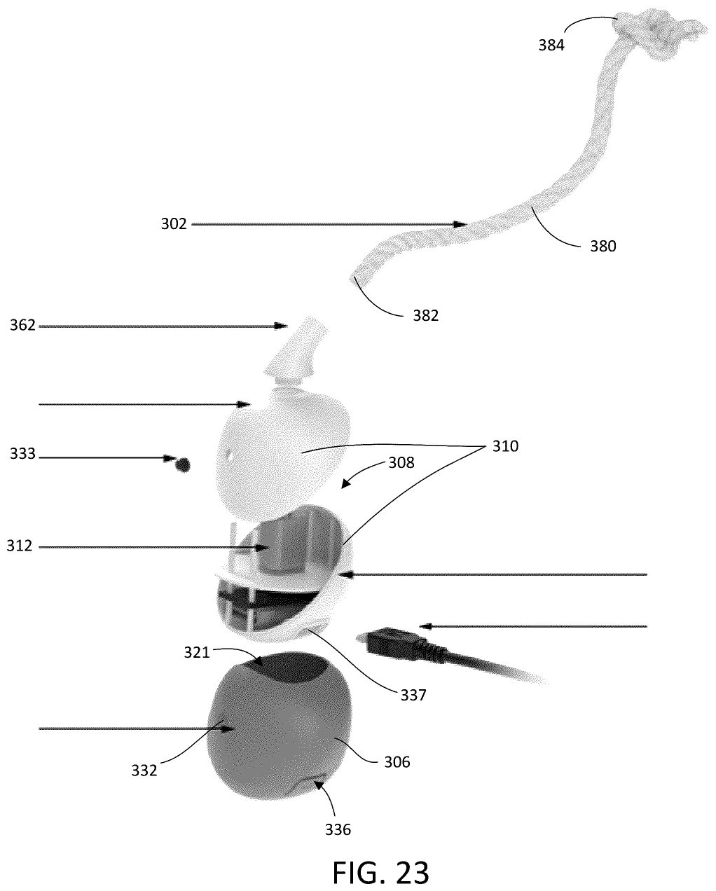

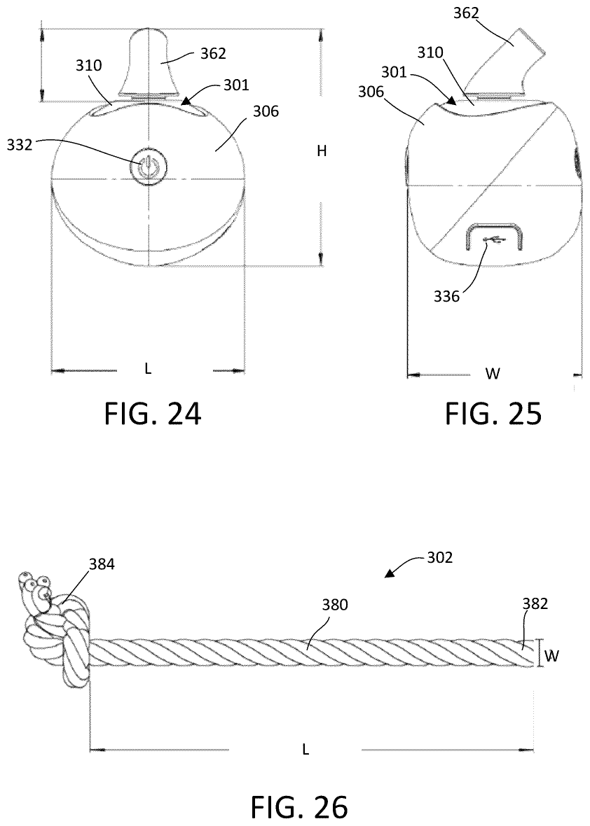

FIGS. 18-26 illustrate an example pet toy 300 that includes a motion assembly 301 (FIGS. 20 and 22-23), a pet engagement member 302 (FIGS. 20, 22-23, and 26), and a cover 303 (FIGS. 18-20). Referring to FIGS. 22-23, the motion assembly 301 includes a housing 306 and a motor assembly 308 at least partially disposed within the housing 306. The housing 306 can be made of a durable material such that pets are inhibited from accessing the motor assembly 308 when playing with the pet toy 300. For example, the housing 306 can be made of thermoplastic rubber (TPR) or any other suitable material that is capable of inhibiting a pet from breaking through the housing 306 and engaging the motor assembly 308.

Still referring to FIGS. 22-25, the housing 306 can include a main opening 321 for receiving a motor assembly housing 310, an activation member 332 (e.g., a button) that is configured to move a motor 312 (FIG. 23) between activated and deactivated configurations, and a charging port 336 for receiving a charging device (e.g., a USB charger) to allow a user to recharge a power source of the motion assembly 301.

Still referring to FIGS. 22-25, the housing 306 can be sized and shaped to facilitate movement of the pet toy 300 and encourage interaction with the pet. In some examples, the housing 306 can have a length L (FIG. 5) of between about 25 mm and about 100 mm, such as about 52 mm. In some examples, the housing 306 can have a height H of between about 20 mm and about 60 mm, such as about 44 mm. In some examples, the housing 306 can have a width W of between about 20 mm and about 80 mm, such as about 47 mm. The housing 306 is shown as having a rounded shape. However, it should be understood that the housing 306 can have any other suitable shape.

Referring to FIG. 23, the motor assembly 308 can include a motor assembly housing 310, a connector 362 rotatably connected to the motor assembly housing 310, a motor 312, and a power source (e.g., a battery). The motor 312 and power source are disposed within the motor assembly housing 310. In the illustrated example, the motor 312 has a motor shaft that is connected to the connector 362 such that movement of the motor shaft causes the connector 362 and, consequently, the pet engagement member 302 to move relative to the motor assembly housing 310. The motor 312 has an activated configuration and a deactivated configuration, where the motor 312 is configured to move the pet engagement member 302 when in the activated configuration. In some examples, the motor 312 is configured to erratically move the pet engagement member 302, such as, for example, by intermittent movement of a motor shaft. Referring to FIG. 22, the motor 312 can be configured to rotate the connector 362 in a direction R (or the opposite direction thereof). In various examples, the motor assembly 308 can include a control circuit (not shown) connected between the motor 312 and the power source, where the control circuit can be configured to cause the motor 312 to move intermittently, change directions, operate at different speeds, and/or operate in a random fashion. In some examples, the control circuit can be configured to move the motor 312 from the activated configuration to the deactivated configuration after a predetermined amount of time (e.g., 10 minutes).

Still referring to FIG. 23, the motor assembly housing 310 can include an activation member 333 (e.g., a button) that is aligned with the activation member 332 of the housing 306 such that engagement of the activation member 332 by a user causes the activation member 333 to engage and move the motor 312 between the activated and deactivated configurations. The motor assembly housing 310 can also include a charging port 337 for receiving a charging device (e.g., a USB charger), where the charging port 337 is aligned with the charging port 336 of the housing 306 such that a user can insert a charging device into the charging portion 337 through the charging port 336.

Referring to FIGS. 22-23 and 26, the pet engagement member 302 can a flexible member 380 having a first end 382 attached to the connector 362 of the motion assembly 301 and a free end 384 that moves erratically as the connector 362 rotates. The free end 384 can include a knot. The first end 382 can connect to the connector 362 by any suitable means that inhibits the first end 382 from being disconnected from the connector 362 by a pet during play. The flexible member 380 can be a rope or any other flexible material that is capable of flexibly moving, or any combination thereof. The flexible member 280 can be made of cotton or any other suitable material. The pet engagement member 302 can have a length L of between about 50 mm and about 100 mm, such as about 76.2 mm. The pet engagement member 302 can have a width W of between about 5 mm and about 10 mm, such as about 7 mm. While the illustrated example shows the pet toy 300 having one pet engagement member, it should be understood that the pet toy 300 can have any suitable number of pet engagement members.

Referring to FIGS. 18-21, the cover 303 is configured to cover the pet engagement member 302 and motion assembly 301. In the illustrated example, the cover 303 includes a top portion 305 and a bottom portion 307 that are connected by a binding portion 374. The top and bottom portions 305, 307 can be made of a flexible material (e.g., nylon) such that the cover 303 flexes or moves when engaged by a moving pet engagement member 202. In some instances, an inner portion of the top and/or bottom portions 305, 307 may have a polyester mesh pad applied to the inner surface of the flexible material to provide added strength to the cover 303 and prevent a pet from tearing apart the cover 203 during play. The outer portion 374 can be durable to prevent a pet from tearing apart the cover 203 during play. The cover 303 can include an access opening 351 that is movable between an open position in which a user can access the motion assembly 301 and the pet engagement member 302 and a closed position in which the motion assembly 301 and pet engagement member 302 are closed within the cover 303. The cover 303 can include, for example, a double-layered hook and loop fastener that allows for the access opening 351 to be moved between the open and closed positions.

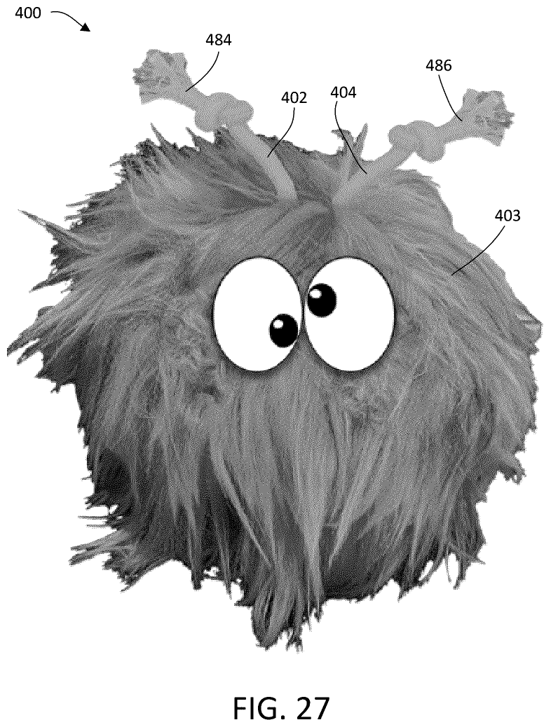

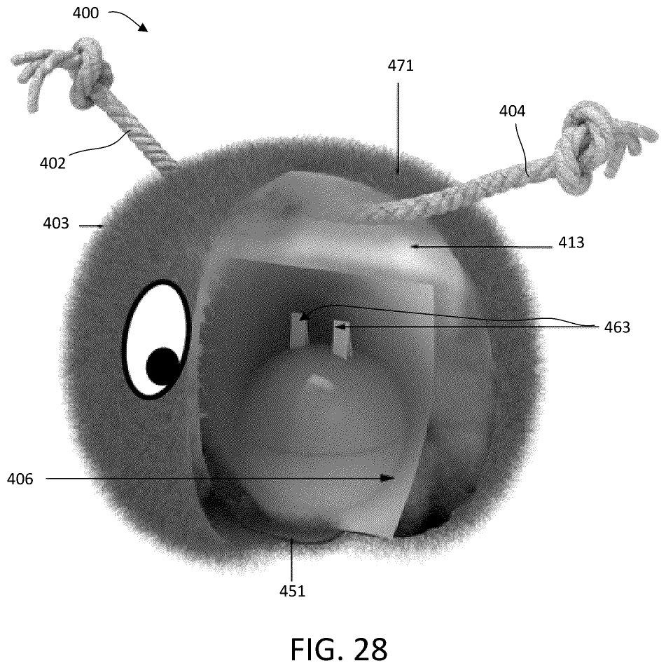

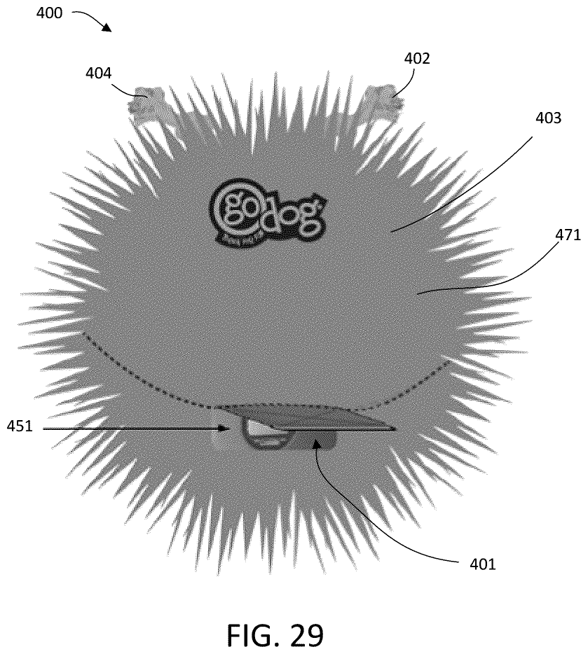

FIGS. 27-37 illustrate an example pet toy 400 that includes a motion assembly 401 (FIGS. 28 and 32-36), first and second pet engagement member 402, 404 (FIGS. 27-29 and 37), and a cover 403 (FIGS. 27-31 and 37). Referring to FIGS. 28 and 32-33, the motion assembly 401 includes an optional cover or pouch 406 and a motor assembly 408 at least partially disposed within the optional cover or pouch 406. The cover or pouch 406 can be made of any suitable material that is capable of holding the motor assembly 408.

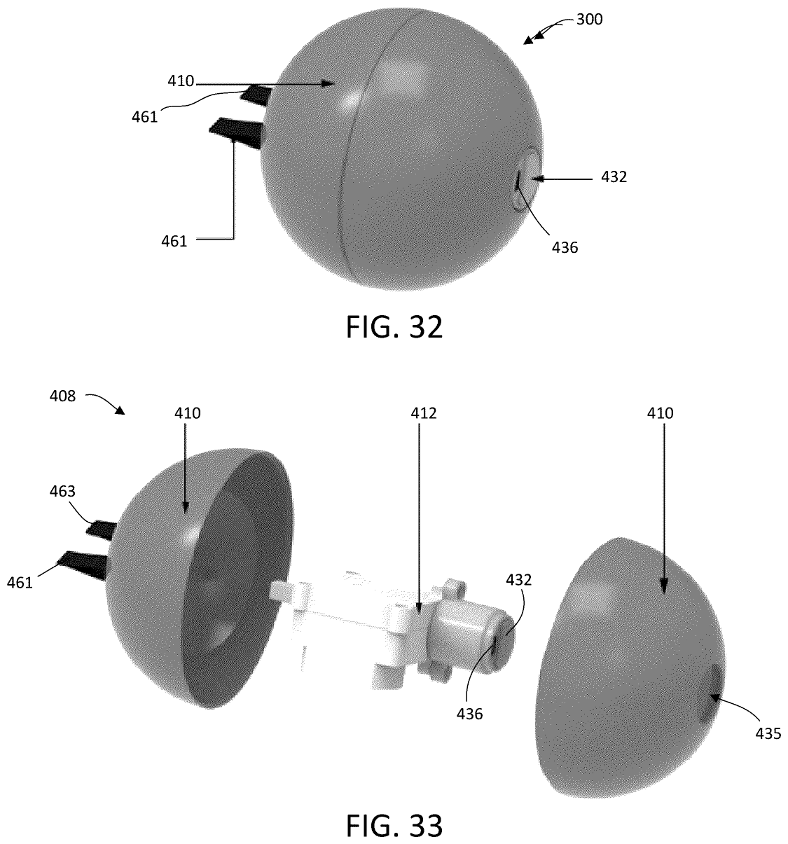

Referring to FIGS. 32-33, the motor assembly 408 can include a motor assembly housing 410, a motor 412, and a power source (e.g., a battery). The motor 412 and power source are disposed within the motor assembly housing 410. The motor 412 can be configured to vibrate and cause cover 403 and, consequently, the pet engagement members 402, 404 to move erratically. The motor 412 has an activated configuration and a deactivated configuration, where the motor 412 is configured to move the pet engagement members 402, 404 when in the activated configuration. In various examples, the motor assembly 408 can include a control circuit (not shown) connected between the motor 412 and the power source, where the control circuit can be configured to cause the motor 412 to move intermittently, change directions, operate at different speeds, and/or operate in a random fashion. In some examples, the control circuit can be configured to move the motor 412 from the activated configuration to the deactivated configuration after a predetermined amount of time (e.g., 10 minutes).

Still referring to FIGS. 32-33, the motor assembly 408 can include an activation member 432 (e.g., a button) that is configured to move a motor 412 (FIG. 23) between activated and deactivated configurations, and a charging port 436 for receiving a charging device (e.g., a USB charger) to allow a user to recharge the power source. In the illustrated example, the motor housing includes an opening 435 for receiving a portion of the motor assembly 408 that includes the activation member 432 and the charging port 436 such that these components can be engaged by a user.

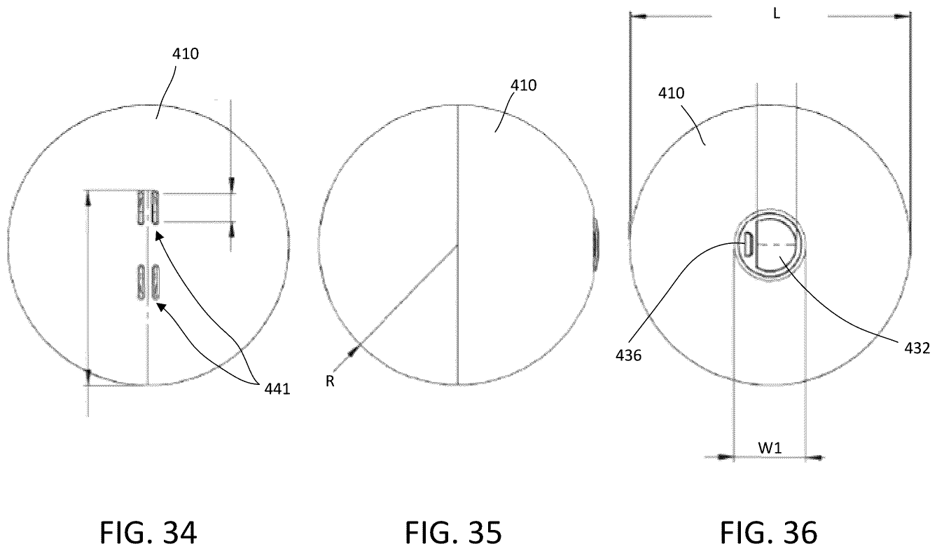

Referring to FIGS. 34-36, in some examples, the motor assembly housing 410 can have a length L (FIG. 36) of between about 50 mm and about 150 mm, such as about 90 mm. In some examples, the housing 410 can be a spherical shape having a radius R of between about 25 mm and about 75 mm, such as about 45 mm. While the housing 410 is shown as having a spherical shape, it should be understood that the housing 410 can have any other suitable shape. The opening 435 of the motor housing 410 can have a width W1 of between about 15 mm and about 30 mm, such as about 23 mm. The motor assembly housing 410 can be made of, for example, acrylonitrile butadiene styrene (ABS) or any other suitable material. In some examples, the motor assembly housing 410 can be made of a material having an easily visible color (e.g., a bright color) such that a user can easily notice the motor assembly housing 410 if the cover 403 is broken, which can indicate to a user that the pet toy 400 needs to have fixed or replaced so that a pet does not engage the motor assembly 408.

Referring to FIGS. 28 and 32-33, the motor assembly 408 can include a first connection element 461 and a second connection element 463. The connection elements 461, 463 can be configured to attach to cover or pouch 406 by, for example, a sewn connection or any other suitable connection to prevent the motor assembly 408 from rotating or otherwise moving relative to an access opening 451 (FIGS. 28-31) of the cover 403. The connection elements 461 can be fixedly attached to the motor assembly housing 410 by one or more openings 441 (FIG. 34). The pouch 406 and/or the connection elements 461, 463 can be connected (e.g., vie a sewn connection) to a seam of the cover 403 to prevent movement of the motor assembly 408 relative to the cover 403.

Referring to FIGS. 27-29 and 37, the first and second pet engagement members 402, 404 extend from the cover 403. The first and second pet engagement members 402, 404 are flexible and have a corresponding free end 484, 486 that moves erratically as motor 412 causes the pet toy 400 to vibrate. In the illustrated example, referring to FIG. 28, the first and second pet engagement members 402, 404 are integral with each other. In other examples, the first and second pet engagement members 402, 404 can be separate components that are separately attached to the cover 403. The pet engagement members 402, 404 can be connected to a seam of the cover 403 by a sewn connection to secure the pet engagement members 402, 404 to the cover 403 and inhibit a pet from disconnecting the pet engagement members 402, 404 from the cover 403 during play. In various examples, the free ends 484, 486 can have a knot. Each of the pet engagement members 402, 404 can be a rope or any other flexible material that is capable of flexibly moving, or any combination thereof. Each of the pet engagement members 402, 404 can be made of cotton or any other suitable material. While the illustrated example shows the pet toy 400 having two pet engagement members, it should be understood that the pet toy 400 can have any suitable number of pet engagement members.

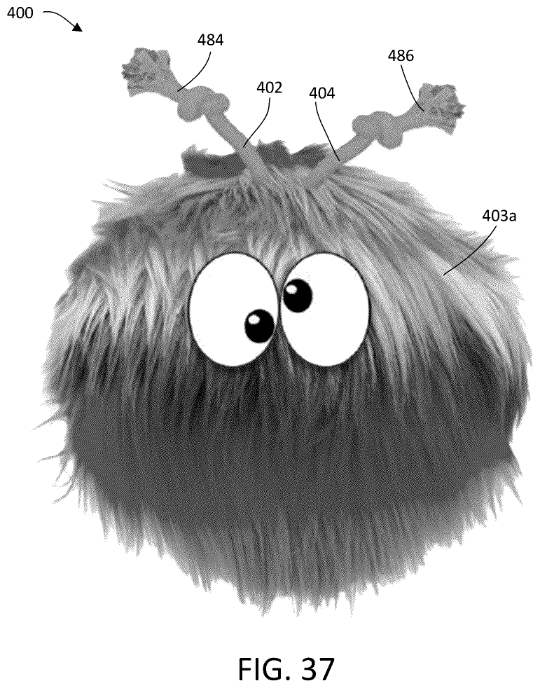

Referring to FIGS. 27-31, the cover 403 is configured to cover the motion assembly 401. In the illustrated example, the cover 303 includes a top layer 471 made of a synthetic fur material and a backing layer (not shown) having a polyester mesh pad that is applied to the inner surface of the top layer to provide added strength to the cover 403 and prevent a pet from tearing apart the cover 403 during play. However, it should be understood that the cover 403 can be made of any other suitable material. In some embodiments, a fill material 413 (FIG. 28) can be disposed between the cover 403 and the motion assembly 401. The fill material 413 can be, for example, polyester fiberfill. Referring to FIG. 37, a second embodiment of a cover 403a for the pet toy 400 can have a different exterior relative to the cover 403 shown in FIGS. 27-31, such as, for example, the cover 403a can have different colors, different material, etc.

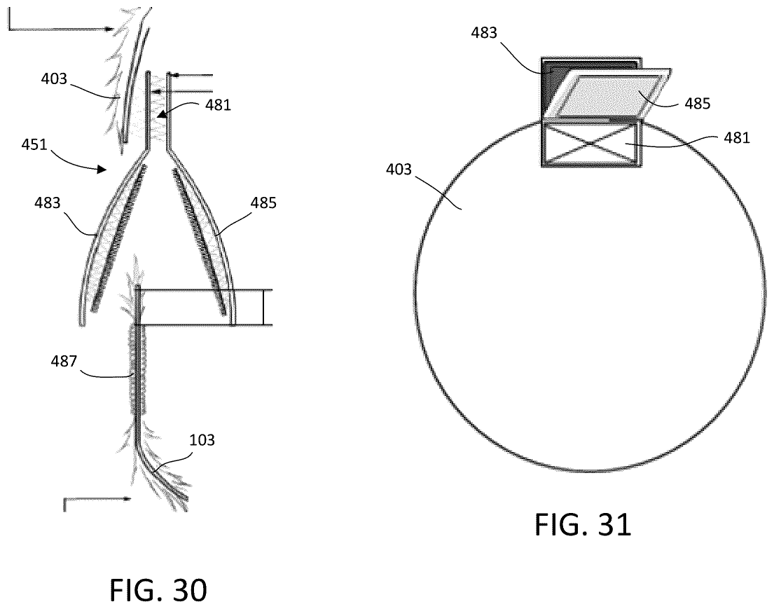

Referring to FIGS. 28-31, the cover 403 can include an access opening 351 that is movable between an open position in which a user can access the motor assembly 408 and a closed position in which the motion assembly 401 is closed within the cover 403. The access opening allows a user to access the activation member 432 and the charging port 436. The cover 403 can include, for example, a double-layered hook and loop fastener that allows for the access opening 451 to be moved between the open and closed positions. For example, referring to FIGS. 30-31, the cover 403 can include a tab portion 481 that is fixedly connected to backing layer (or any other suitable portion) of the cover 403 and disposed on a first side of the access opening 451. First and second connectors 483, 485 can extend from the tab portion 481, where each of the first and second connectors 483, 485 have one of hooks or loops of a hook and loop fastener. A third connector 487 can be secured to other side of the access opening 451 relative to the tab portion 481, where the third connector can have the other of hooks or loops of a hook and loop fastener disposed on both of its interior and exterior surfaces. The first connector 483 can be configured to removably attach to the exterior surface of the connector 487, and the second connector 483 can be configured to removable attach to the interior surface of the connector 487. However, it should be understood that the access opening 451 can be configured to move between the open and closed configurations by any other suitable means.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed:

1. A pet toy comprising:
a motion assembly that includes a motor, wherein the motor has an activated configuration and a deactivated configuration; and
a pet engagement member that is configured to move erratically when the motor is in the activated configuration.

2. The pet toy of claim 1, wherein the motion assembly comprises:
a housing; and
a motor assembly disposed within the housing, the motor assembly comprising a motor assembly housing, a motor disposed within the motor assembly housing, and a power source;
wherein the motor of the motor assembly is configured to move the housing such that the housing moves erratically.

3. The pet toy of claim 1, a first pet engagement member extending from a first side of the housing, the first pet engagement member comprising a flexible material such that the first pet engagement member flexibly moves when the motor causes the housing to move erratically.

4. The pet toy of claim 3, further comprising a second pet engagement member extending from a second side of the housing that is opposite the first side, the second pet engagement member comprising a flexible material such that the second pet engagement member flexibly moves when the motor causes the housing to move erratically.

5. The pet toy of claim 4, wherein the first pet engagement member and the second pet engagement member are formed from a single component.

6. The pet toy of claim 4, wherein each of the first pet engagement member and the second pet engagement member has a main body, a first stop member that is at an exposed end of the main body, and a second stop member that is at an opposite end of the main body, wherein the second stop member is disposed within the housing of the motion assembly.

7. The pet toy of claim 1, wherein the motion assembly comprises a housing that includes a main portion and a suction member that is configured to removably connect the main portion to a play surface.

8. The pet toy of claim 1, further comprising:
a motor assembly disposed within the main portion of the housing, the motor assembly comprising a motor and a power source; and
at least one pet engagement member connected to the motor of the motor assembly, wherein the pet engagement member comprises a flexible material.

9. The pet toy of claim 8, further comprising a cover fixed to the housing of the motion assembly, wherein the cover covers a portion of the housing and the at least one pet engagement member.

10. The pet toy of claim 9, wherein:
the motor is configured to move the at least one pet engagement relative to the housing; and
the at least one pet engagement member is removably connected to the motor of the motor assembly via a connector.

11. The pet toy of claim 10, wherein the connector of the at least one pet engagement member is configured to disconnect from the motor if a force applied to the at least one pet engagement member by a pet during play exceeds a predetermined threshold.

12. The pet toy of claim 1, wherein the motion assembly further comprises:
a housing that includes at least one of an activation member and a charging port; and
a motor assembly disposed within the housing, the motor assembly comprising a motor and a power source.

13. The pet toy of claim 12, wherein the motion assembly further comprises:
at least one pet engagement member connected to the motor of the motor assembly, wherein the pet engagement member comprises a flexible material; and
a cover attached to the housing of the motion assembly, wherein the cover covers a portion of the housing that includes the at least one of the activation member and the charging port and the at least one pet engagement member;
wherein the motor is configured to move the at least one pet engagement relative to the housing.

14. The pet toy of claim 13, further comprising a cover having a top member and a bottom member that are affixed together to create an interior cavity, wherein the motion assembly and the at least one pet engagement member are disposed within the interior cavity of the cover.

15. The pet toy of claim 1, further comprising:
a cover having a top layer made of a synthetic fur material and a backing layer that includes a flexible mesh material;
wherein the motion assembly is disposed within the cover.

16. The pet toy of claim 15, wherein the motion assembly comprises:
a pouch;
a motor assembly disposed within the pouch, the motor assembly comprising a motor assembly housing, a motor disposed within the motor assembly housing, a power source disposed in the motor assembly housing and one or more connectors for securing the motor assembly to the pouch;
wherein the motor of the motor assembly is configured to cause the motor housing to vibrate.

17. The pet toy of claim 16, further comprising at least one pet engagement member extending from the cover, the at least one pet engagement member comprising a flexible material such that the pet engagement member flexibly moves when the motor causes the housing to vibrate.

18. The pet toy of claim 17, wherein at least one of the pouch of the motion assembly and the one or more connectors of the motor assembly are secured to the cover to maintain the motor assembly in a desired position within the cover.

19. A pet toy comprising:
a housing comprising an activation member and a charging port;
a motor assembly disposed within the housing, the motor assembly comprising a motor and a power source, wherein the motor has an activated configuration and a deactivated configuration; and
a pet engagement member that is configured to move erratically when the motor is in the activated configuration;
wherein actuating the activation member switches the motor from the deactivated configuration to the activated configuration; and
wherein the motor switches from the activated configuration to the deactivated configuration not more than 10 minutes after the actuation of the activation member.

20. A pet toy comprising:
a housing comprising a main portion, a suction member that is configured to removably connect the main portion to a play surface, an activation member, and a charging port;
a motor assembly disposed within the housing, the motor assembly comprising a motor and a power source, wherein the motor has an activated configuration and a deactivated configuration;
a pet engagement member is removably connected to the motor of the motor assembly via a connector, wherein the motor is configured to move the at least one pet engagement relative to the housing, and wherein the pet engagement member is configured to move erratically when the motor is in the activated configuration;
wherein actuating the activation member switches the motor from the deactivated configuration to the activated configuration; and
wherein the motor switches from the activated configuration to the deactivated configuration not more than 10 minutes after the actuation of the activation member.
